(19) United States
(12) Patent Application Publication
(10) Pub. No.: US 2023/0245074 A1
(43) Pub. Date: Aug. 3, 2023

(54) MEETING MANAGEMENT APPARATUS, MEETING MANAGEMENT METHOD, AND MEETING MANAGEMENT SYSTEM

(71) Applicant: V-CUBE, INC., Tokyo (JP)

(72) Inventors: Yosuke KAMEZAKI, Tokyo (JP); Hironori NURISHI, Tokyo (JP); Ei SOU, Tokyo (JP); Ken KOSEKI, Tokyo (JP)

(21) Appl. No.: 18/299,055

(22) Filed: Apr. 12, 2023

Related U.S. Application Data
(63) Continuation of application No. PCT/JP2021/037670, filed on Oct. 12, 2021.

(30) Foreign Application Priority Data
Oct. 26, 2020 (JP) 2020-178879

(51) Int. Cl. G06Q 10/1093

(52) U.S. Cl. CPC G06Q 10/1095

(57) ABSTRACT

A meeting management apparatus manages a plurality of group meetings that a plurality of attendees can attend using a communication terminal. The meeting management apparatus includes: a memory that stores meeting attribute data indicating an attribute of a group meeting in association with each of the plurality of group meetings; and a terminal control part that transmits meeting attribute data corresponding to each of the plurality of group meetings to an attendee terminal, in association with meeting identification information for identifying each of the plurality of group meetings.

### CROSS-REFERENCE TO RELATED APPLICATIONS

The present application is a continuation application of International Application number PCT/JP2021/037670, filed on Oct. 12, 2021, which claims priority under 35 U.S.C § 119(a) to Japanese Patent Application No. 2020-178879, filed on Oct. 26, 2020, contents of which are incorporated herein by reference in their entirety.

### BACKGROUND OF THE INVENTION

The present disclosure relates to a meeting management apparatus, a meeting management method, and a meeting management system for managing meetings performed via a network.

There is known a technique for performing a meeting by transmitting and receiving audio signals via a network. Japanese Unexamined Patent Application Publication No. 2020-144476 discloses a meeting system that enables the performance of a plurality of group meetings.

In a venue such as a product exhibition, an attendee can view presentations given by various exhibitor companies by visiting exhibition booths of a plurality of companies. The attendee can view presentations given by exhibitor companies via a network by using a group meeting function of a meeting system.

However, when the attendee using a conventional meeting system views presentations given by exhibitor companies, it is difficult for the attendee to previously know the content of information that he/she can get by attending each group meeting, unlike a case where the attendee walks around an exhibition site. Therefore, it is difficult for the attendee to determine which group meeting he/she should attend.

### BRIEF SUMMARY OF THE INVENTION

The present disclosure has been made in view of these points, and its object is to make it easier for an attendee who is to attend a meeting via a network to determine which group meeting he/she should attend.

A meeting management apparatus according to a first aspect of the present disclosure is a meeting management apparatus managing a plurality of group meetings that a plurality of attendees can attend using a communication terminal, the meeting management apparatus includes: a storage part that stores meeting attribute data indicating an attribute of the group meeting in association with each of the plurality of group meetings; and a terminal control part that transmits, to the communication terminal, the meeting attribute data corresponding to each of the plurality of group meetings in association with meeting identification information for identifying each of the plurality of group meetings.

A meeting management method according to a second aspect of the present disclosure is a meeting management method, executed by a computer, for managing a plurality of group meetings that a plurality of attendees can attend using a communication terminal, the meeting management method includes the steps of: reading meeting attribute data indicating an attribute of the group meeting stored in a storage part in association with each of the plurality of group meetings; and transmitting the meeting attribute data corresponding to each of the plurality of group meetings to the communication terminal, in association with meeting identification information for identifying each of the plurality of group meetings.

A meeting management system according to a third aspect of the present disclosure is a meeting management system including: a plurality of communication terminals used by a plurality of attendees; and a meeting management apparatus managing a plurality of group meetings that the attendee can attend using the communication terminal, wherein the meeting management apparatus includes: a storage part that stores meeting attribute data indicating an attribute of the group meeting in association with each of the plurality of group meetings; and a terminal control part that transmits the meeting attribute data corresponding to each of the plurality of group meetings to the communication terminal, in association with meeting identification information for identifying each of the plurality of group meetings, wherein the communication terminal includes: a receiver that receives the meeting attribute data; and a display that displays the meeting attribute data received by the receiver at a position corresponding to the group meeting according to the meeting attribute data.

### BRIEF DESCRIPTION OF THE DRAWINGS

FIG. 1 shows a configuration of a meeting management system.

FIG. 2 shows a screen for selecting a group meeting that an attendee will attend.

FIG. 3 shows an example of a screen in the group meeting.

FIG. 4 shows another example of a screen in the group meeting.

FIG. 5 shows configurations of a meeting management apparatus and an attendee terminal.

FIG. 6 shows attendee management data.

FIG. 7 shows group meeting management data.

FIG. 8 shows an example of a screen where meeting attribute data is displayed.

FIG. 9 shows an example of a screen where attributes of a group meeting that matches attributes of the attendee are displayed.

FIG. 10 shows an example of a screen including an area for searching for a group meeting.

FIG. 11 is a flowchart showing an example of a flow of processing in the meeting management apparatus.

FIG. 12 shows a configuration of a meeting management apparatus according to a modified example.

### DETAILED DESCRIPTION OF THE INVENTION

Hereinafter, the present disclosure will be described through exemplary embodiments, but the following exemplary embodiments do not limit the invention according to the claims, and not all of the combinations of features described in the exemplary embodiments are necessarily essential to the solution means of the invention.

### [Outline of the Meeting Management System S]

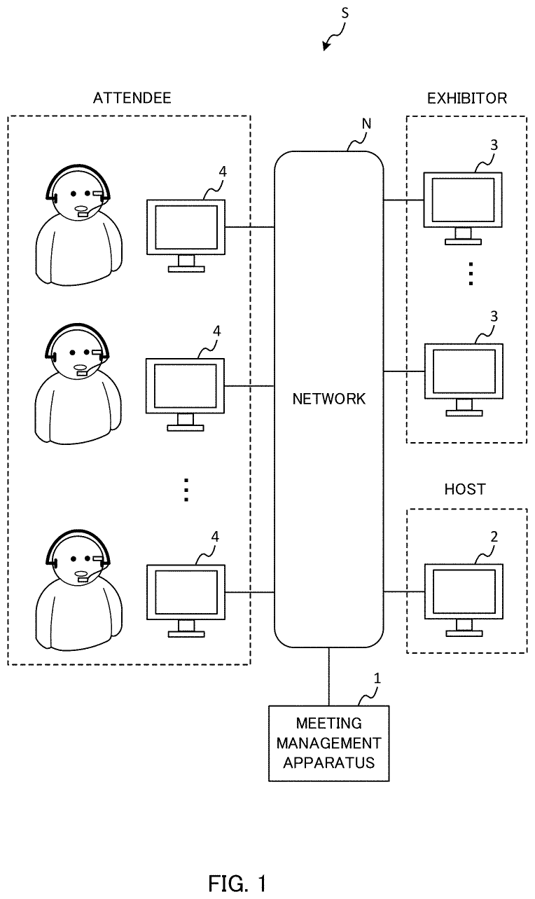

FIG. 1 shows a configuration of a meeting management system S. The meeting management system S is a system for enabling a plurality of group meetings to be performed online in parallel. The meeting management system S is suitable for an online event where people in charge of a plurality of exhibitor companies who wish to introduce their products or services and a plurality of attendees who wish to obtain information concerning products or services can exchange information, but the application of the meeting management system S is not limited.

In the example shown in FIG. 1, the meeting management system S includes a meeting management apparatus 1, a host terminal 2, a plurality of exhibitor terminals 3, and a plurality of attendee terminals 4. The meeting management apparatus 1 is a device for managing a plurality of group meetings that a plurality of attendees can attend using communication terminals. The meeting management apparatus 1 is a server that executes data processing for realizing a plurality of group meetings, and is managed by organizers (e.g., hosts of an event) of the plurality of group meetings, for example.

The meeting management apparatus 1 causes the plurality of exhibitor terminals 3 and the plurality of attendee terminals 4 to display a screen for attending the plurality of group meetings via a network N so that a plurality of people can attend the plurality of group meetings. The meeting management apparatus 1 provides an exhibitor terminal 3 and an attendee terminal 4 registered in advance with a web application, thereby allowing the exhibitor terminal 3 and the attendee terminal 4 to attend the group meeting. Details of the meeting management apparatus 1 will be described later.

The host terminal 2 is a communication terminal used by the organizers of the plurality of group meetings, and is, for example, a computer. An organizer performs various initial settings for the plurality of group meetings. For example, the organizer sets the number of people who can attend each group meeting, and sets the size of a booth corresponding to each group meeting in a layout diagram (map) of an event venue to be displayed on the plurality of exhibitor terminals 3 and the plurality of attendee terminals 4, via the host terminal 2.

The exhibitor terminal 3 is a communication terminal used by a person in charge of an exhibitor company that is to attend a group meeting (hereinafter referred to as “person in charge”), and is, for example, a computer, a tablet, or a smartphone. The exhibitor terminal 3 is disposed in an office of the exhibitor company, and is operated by one or more people in charge of the exhibitor company to transmit and receive various types of data to and from the attendee terminal 4 via the meeting management apparatus 1. The exhibitor terminal 3 transmits, to the meeting management apparatus 1, image data for a presentation, audio data of the person in charge, and text data input by the person in charge, for example.

The attendee terminal 4 is a communication terminal used by a visitor to an event who will attend a group meeting (hereinafter referred to as an “attendee”), and is, for example, a computer, a tablet, or a smartphone. The attendee terminal 4 is operated by the attendee to transmit and receive various types of data to and from the exhibitor terminal 3 via the meeting management apparatus 1. The attendee terminal 4 receives image data, audio data, and text data transmitted from the exhibitor terminal 3, and displays the received data on a screen.

The meeting management apparatus 1 generates various types of data for exchanging information between a plurality of people in charge and a plurality of attendees, and displays the generated, various types of data on screens of the exhibitor terminal 3 and the attendee terminal 4. The meeting management apparatus 1 displays an image indicating booths of the plurality of group meetings that can be attended using the plurality of attendee terminals 4 on the screen of the attendee terminal 4, and allows the attendee to select a group meeting that he/she wishes to attend. A group meeting in this embodiment corresponds to a booth in an event venue, and the attendee can attend a group meeting applied for previously or can shift to another group meeting by operating the attendee terminal 4.

A person in charge using the exhibitor terminal 3 and the attendee using the attendee terminal 4 can communicate with each other by sending and receiving text messages to and from each other using a chat feature or by individually sending and receiving voices. The attendee can send text messages to ask questions while the person in charge of the exhibitor company is giving a presentation in the group meeting, or can have voice conversation with the person in charge individually after the presentation, for example.

### Examples of Screens

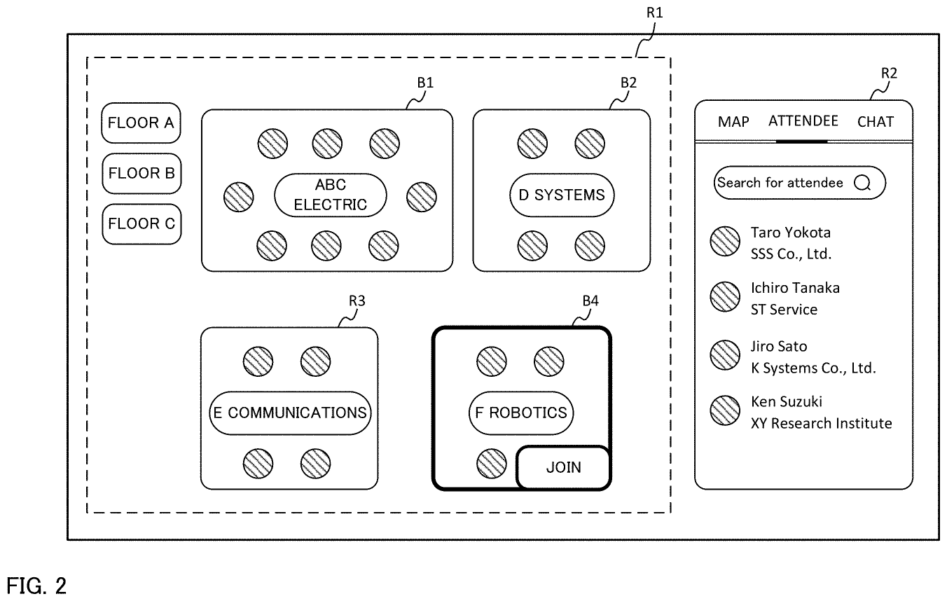

FIGS. 2 to 4 show examples of screens displayed on the attendee terminal 4. FIG. 2 is a screen for selecting a group meeting that the attendee will attend. The names of exhibitor companies organizing group meetings are displayed in an area R1 of FIG. 2, as an outline of the plurality of group meetings. Specifically, the following group meetings are displayed: a group meeting of ABC electric as a booth B1; a group meeting of D systems as a booth B2; a group meeting of E communications as a booth B3; and a group meeting of F robotics as a booth B4.

An image of a circle with diagonal lines shown in each booth is an icon image corresponding to an attendee. Although the icon image in FIG. 2 is represented by diagonal lines, the icon image may be an image including information for identifying an attendee, such as a face image of the attendee.

The attendee can attend the group meeting corresponding to a selected booth by performing an operation for selecting a booth to attend on the screen of FIG. 2 (e.g., a click operation or a touch operation). FIG. 2 shows a state where the attendee has selected a group meeting of the booth B4.

Various types of information that the attendee can utilize are displayed on an area R2 of FIG. 2. Specifically, in the area R2, a list of attendees at the group meeting that the attendee is attending is displayed, a chat message exchanged with a person in charge is displayed, or a map indicating the layout of the venue is displayed. In FIG. 2, a list of attendees attending the group meeting of the booth B4 is displayed in response to the attendee selecting the group meeting of the booth B4.

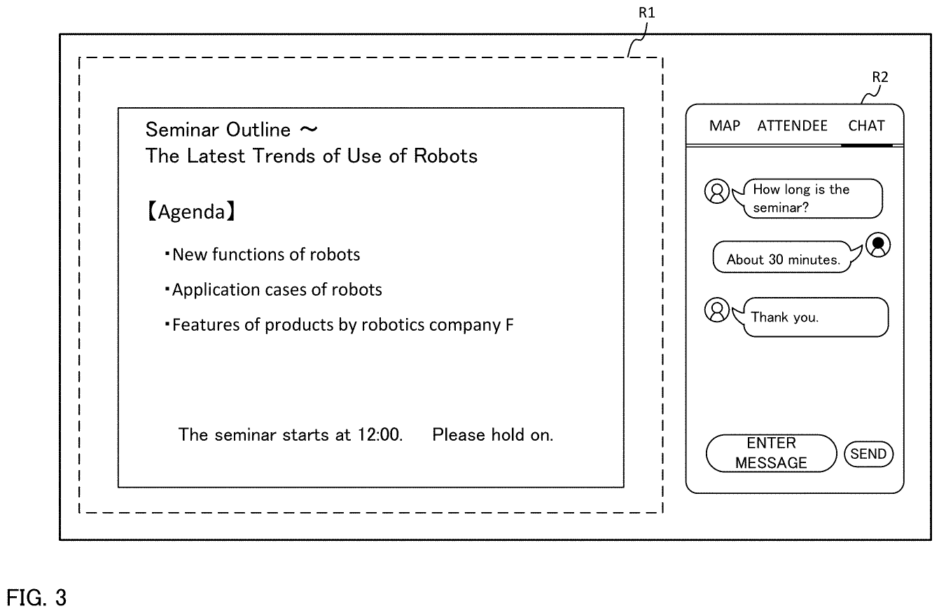

If the attendee selects a display area “join” displayed on the selected booth B4 on the screen shown in FIG. 2, it is determined that the attendee is to attend the group meeting, and the attendee terminal 4 causes a screen in the group meeting to be displayed. FIG. 3 shows an example of a screen in the group meeting. Presentation materials prepared by the exhibitor company are displayed in an area R1 of FIG. 3. A screen for chatting is displayed in an area R2 of FIG. 3. The attendee can send and receive messages to and from a person in charge of the exhibitor company, using a chat screen displayed in the area R2. An operation image for switching whether to or not to send a voice or an image of the attendee may be provided in the area R1 of FIG. 3.

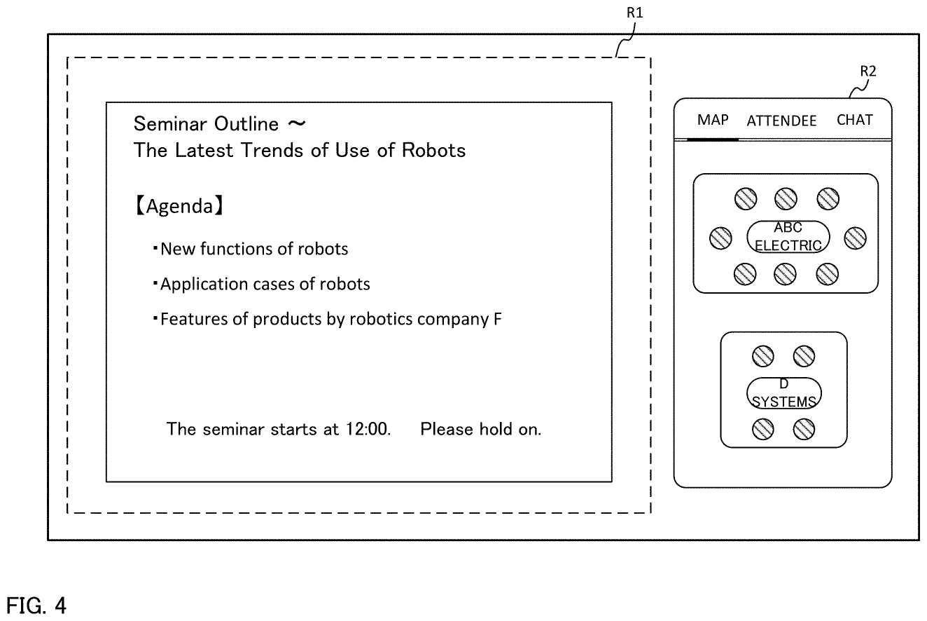

FIG. 4 shows another example of a screen in the group meeting. If the attendee selects a “map” in the area R2 of the screen shown in FIG. 3, the attendee terminal 4 displays the screen shown in FIG. 4. On this screen, an outline of each booth shown in the area R1 of FIG. 2 is displayed in a reduced size, and the attendee can check the states of other group meetings while attending the group meeting. The attendee can shift to another group meeting by performing an operation of selecting the other group meeting displayed in the area R2.

The meeting management system S according to the present embodiment is characterized in that the attendee terminal 4 is provided with information for the attendee, who is to attend an event holding a plurality of group meetings, to determine which group meeting he/she should attend, thereby making it easier for the attendee to determine which group meeting he/she should attend. Specifically, the meeting management apparatus 1 transmits data indicating attributes of each group meeting to the attendee terminal 4, and the attendee terminal 4 presents information indicating the attributes of each group meeting to the attendee.

Attributes of a group meeting are, for example, the name of a company organizing a booth of the group meeting, the logo of the company, content of the exhibition, content of a seminar offered in the group meeting, attendance eligibility for the group meeting (e.g., whether an invitation is required), and whether a fee is required. Since the attendee terminal 4 displays attributes of each group meeting, the attendee can easily grasp which group meeting matches attributes or preferences of the attendee. Therefore, even in an online event where it is difficult to take a look at a large number of group meetings, it is possible to prevent the attendee from missing a group meeting suitable for the attendee.

### [Outlines of the Meeting Management Apparatus 1 and the Attendee Terminal 4]

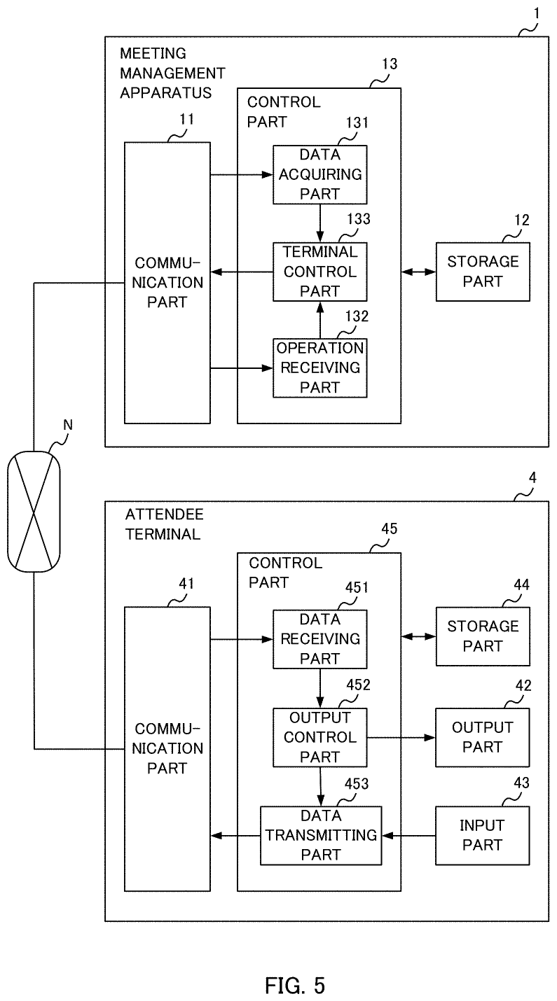

FIG. 5 shows configurations of the meeting management apparatus 1 and the attendee terminal 4. Since the exhibitor terminal 3 has a configuration equivalent to that of the attendee terminal 4, a description thereof will be omitted.

The meeting management apparatus 1 includes a communication part 11, a storage part 12, and a control part 13. The control part 13 includes a data acquiring part 131, an operation receiving part 132, and a terminal control part 133.

The communication part 11 includes a communication controller for transmitting and receiving various types of data via the network N. The communication part 11 notifies the data acquiring part 131 of image data or sound data generated in a group meeting. Further, the communication part 11 notifies the operation receiving part 132 of data for a setting operation received from the host terminal 2, the exhibitor terminal 3, or the attendee terminal 4. Furthermore, the communication part 11 transmits the image data or sound data input from the terminal control part 133, to the host terminal 2, the exhibitor terminal 3, or the attendee terminal 4.

The storage part 12 includes storage media such as a Read Only Memory (ROM), a Random Access Memory (RAM), and a Solid State Drive (SSD). The storage part 12 stores a program executed by the control part 13. The storage part 12 stores various types of data related to the group meeting. The storage part 12 stores meeting attribute data indicating attributes of a group meeting in association with each of the plurality of group meetings, for example. It should be noted that the storage part 12 may be referred to as a memory.

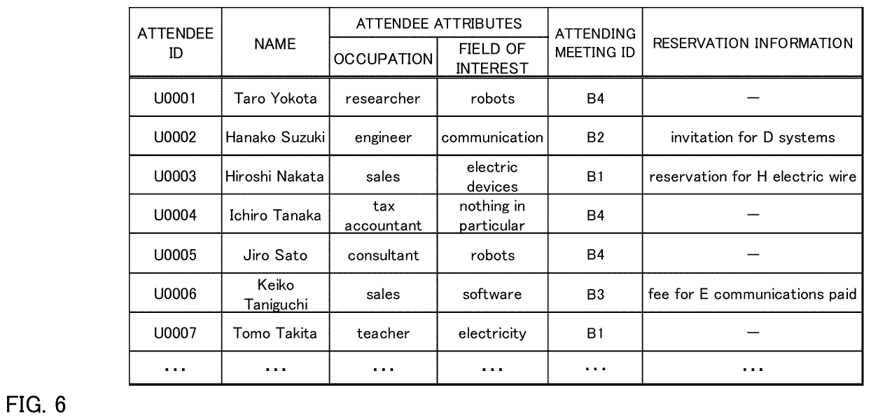

FIG. 6 shows attendee management data, which is an example of data stored in the storage part 12. In the attendee management data, an attendee ID, the name of an attendee, attributes of the attendee, an attending meeting ID for identifying the meeting that the attendee is attending, and reservation information are associated with each other. The attributes of the attendee are occupation, age, field of interest, or place of work, for example. The reservation information is information indicating whether the attendee made a reservation for attendance in advance, whether the attendee received an invitation, or whether the attendee paid a fee, for example.

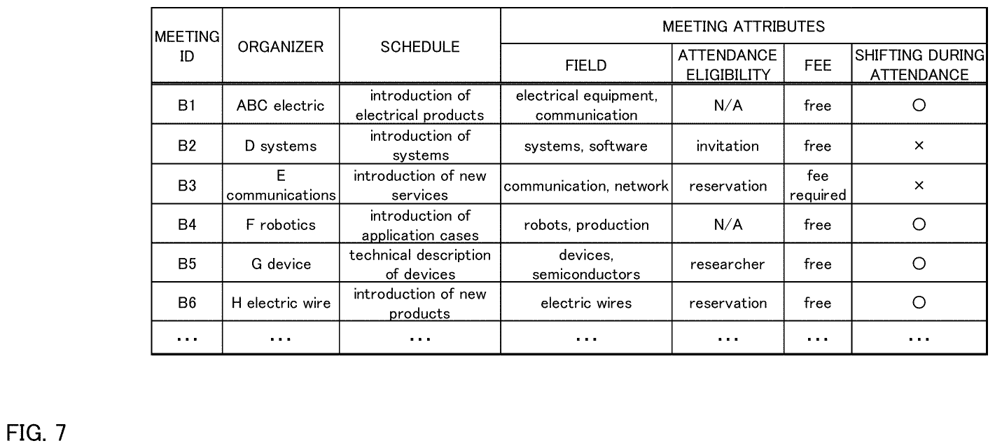

FIG. 7 shows group meeting management data, which is another example of data stored in the storage part 12. As shown in FIG. 7, a meeting ID, an organizer name, a schedule (content, a timetable, or the like) of a group meeting, and meeting attributes are associated with each other in the group meeting management data. The meeting attributes include fields that the group meeting is related to, attendance eligibility, an attendance fee, and whether or not it is allowable to shift to another meeting during attendance. The meeting attributes are set by the person in charge of the exhibitor company organizing the group meeting, for example, and are transmitted from the exhibitor terminal 3. The meeting attributes may include a keyword used in the meeting.

“Invitation” in the section “attendance eligibility” indicates that an invitation for the group meeting is required. “Reserved” indicates that having a reservation to attend the group meeting is required. “Researcher” indicates that the attendee's occupation is required to be a researcher. An organizer (exhibitor company) of the group meeting sets occupations and qualifications of desired attendees as attributes of a meeting, and therefore the organizer can have more attendees, who are targets, attend the meeting.

“Shifting during attendance” indicates whether it is allowable (0) or not (X) to shift to another group meeting while attending the group meeting. In the section “shifting during attendance”, whether or not it is allowable to shift may be set for each time period.

Returning to FIG. 5, the control part 13 will be described. The control part 13 includes a Central Processing Unit (CPU), for example. The control part 13 functions as the data acquiring part 131, the operation receiving part 132, and the terminal control part 133 by executing a program stored in the storage part 12. Details of the data acquiring part 131, the operation receiving part 132, and the terminal control part 133 will be described later. It should be noted that the control part 13 may be referred to as a processor.

The attendee terminal 4 includes a communication part 41, an output part 42, an input part 43, a storage part 44, and a control part 45. The control part 45 includes a data receiving part 451, an output control part 452, and a data transmitting part 453.

Similar to the communication part 11, the communication part 41 includes a communication controller for transmitting and receiving various types of data via the network N. The communication part 41 receives image data and sound data transmitted from the exhibitor terminal 3 via the network N and the meeting management apparatus 1, for example. The communication part 41 inputs the received data to the data receiving part 451. Further, the communication part 41 acquires, from the data transmitting part 453, sound data based on voice input by the attendee using the attendee terminal 4 and text data input by the attendee using the attendee terminal 4, and then transmits the acquired data.

The output part 42 includes a display that functions as a display displaying various types of image data, and a speaker that outputs sound data. In response to an instruction from the output control part 452, the output part 42 displays an image related to the group meeting as shown in FIGS. 2 to 4 on the display, and outputs, to the speaker, sounds generated in the group meeting that the attendee is attending. Further, the output part 42 displays the meeting attribute data on the display.

The input part 43 is a device that receives an operation made by the attendee using the attendee terminal 4, and is, for example, a keyboard, a mouse, or a touch panel. The input part 43 notifies the data transmitting part 453 of data based on an operation input by the attendee.

The storage part 44 includes storage media such as a ROM, a RAM, and an SSD. The storage part 44 stores a program executed by the control part 13.

The control part 45 includes a CPU, for example. The control part 45 functions as the data receiving part 451, the output control part 452, and the data transmitting part 453 by executing a program stored in the storage part 44.

The data receiving part 451 is a receiver that receives various types of data from the meeting management apparatus 1 via the communication part 41. The data receiving part 451 receives meeting attribute data indicating attributes of a plurality of group meetings, for example. The data receiving part 451 inputs the received meeting attribute data to the output control part 452.

The output control part 452 causes the output part 42 to output the data transmitted from the meeting management apparatus 1. The output control part 452 causes an image based on image data to be displayed on the display, and causes a speaker to output a sound based on sound data, for example. The output control part 452 causes the meeting attribute data transmitted from the meeting management apparatus 1 to be displayed at a position corresponding to the group meeting according to the meeting attribute data on the display (e.g., a position of a booth indicated by the meeting management apparatus 1).

The data transmitting part 453 transmits the data input by the attendee via the input part 43 to the meeting management apparatus 1. The data transmitting part 453 transmits information for identifying the group meeting selected by the attendee to the meeting management apparatus 1, for example.

### [Configuration of the Control Part 13]

Next, a configuration and operation of the control part 13 will be described in detail.

The data acquiring part 131 acquires various types of data from the host terminal 2, the exhibitor terminal 3, and the attendee terminal 4 via the communication part 11. The data acquiring part 131 acquires image data for presentations from the exhibitor terminal 3, and acquires sound data indicating sounds generated by users of each terminal, from the exhibitor terminal 3 and the attendee terminal 4, for example. The data acquiring part 131 notifies the terminal control part 133 of the acquired image data and sound data. Further, the data acquiring part 131 acquires meeting attribute data indicating attributes of each of the plurality of group meetings. The data acquiring part 131 notifies the terminal control part 133 of the acquired meeting attribute data.

The operation receiving part 132 receives various operations from the attendee terminal 4 via the communication part 11. The operation receiving part 132 receives, from the attendee terminal 4, a selection operation for selecting at least one of the plurality of group meetings. The operation receiving part 132 receives an operation of selecting the group meeting by acquiring information for identifying the group meeting selected by the attendee from among the plurality of group meetings, as displayed on the screen shown in FIG. 2.

The operation receiving part 132 receives an operation to “join” by acquiring information for specifying that the attendee has performed an operation to “join” on the screen shown in FIG. 2. When receiving an operation to “join”, the operation receiving part 132 may update an attendee meeting ID corresponding to the attendee who performed the operation to “join”, in the attendee management data stored in the storage part 12.

Further, the operation receiving part 132 may receive a keyword input by the attendee using the attendee terminal 4 in order to search for a group meeting. The operation receiving part 132 notifies the terminal control part 133 of the received keyword.

The operation receiving part 132 receives an operation of setting the meeting attribute data from the host terminal 2 or the exhibitor terminal 3 via the communication part 11. The operation receiving part 132 receives, from the host terminal 2 or the exhibitor terminal 3, a setting of whether or not the attendee is allowed to shift to another group meeting while the group meeting is ongoing, in association with meeting identification information (hereinafter referred to as a “meeting ID”) for identifying the group meeting, for example. Further, the operation receiving part 132 receives an operation of setting the attendee management data from the host terminal 2, the exhibitor terminal 3, or the attendee terminal 4 via the communication part 11.

The terminal control part 133 transmits various types of data to the exhibitor terminal 3 and the attendee terminal 4 via the communication part 11, thereby causing various screens to be displayed on the exhibitor terminal 3 and the attendee terminal 4. The terminal control part 133 displays the screens shown in FIGS. 2 to 4 on the attendee terminal 4 by transmitting data necessary for the attendee terminal 4 to display the screens shown in FIGS. 2 to 4, for example. Then, the terminal control part 133 realizes the group meeting by relaying various types of data transmitted from the exhibitor terminal 3 and the attendee terminal 4, and allowing the exhibitor and the attendee to exchange various types of information.

Further, the terminal control part 133 reads meeting attribute data corresponding to each of the plurality of group meetings from the storage part 12, and transmits the read meeting attribute data to the attendee terminal 4 in association with meeting IDs for identifying each of the plurality of group meetings. The terminal control part 133 may transmit the meeting attribute data in association with information indicating a position of an area where a booth of each of the plurality of group meetings is to be displayed, such that a text or an image based on the meeting attribute data can be displayed at a position corresponding to the booth of the group meeting by the attendee terminal 4.

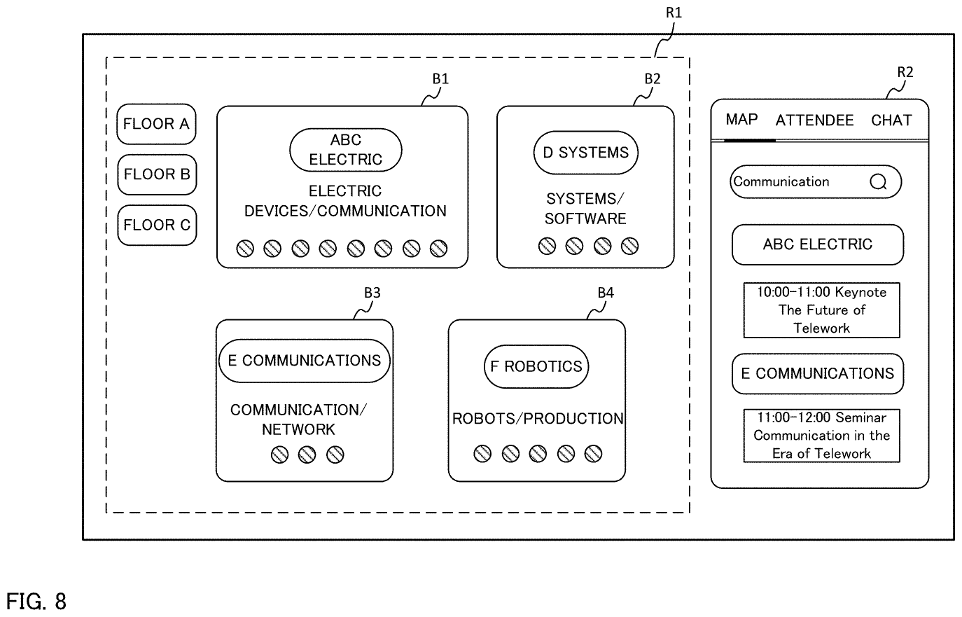

FIG. 8 shows an example of a screen where the meeting attribute data is displayed. In the example shown in FIG. 8, fields that the group meeting is related to are shown as the meeting attribute data under the name of an exhibitor company organizing each group meeting. A circle with diagonal lines below is an icon image corresponding to an attendee attending the group meeting. The attendee using the attendee terminal 4 can easily determine whether or not a talk to be given in each group meeting is useful to him/her by looking at such a screen.

The terminal control part 133 may transmit, to the attendee terminal 4, meeting attribute data of one or more group meetings selected from a plurality of group meetings on the basis of a relationship between the attendee attribute data and the meeting attribute data. For example, the terminal control part 133 selects a group meeting having meeting attributes of a field corresponding to a field that the attendee, using the attendee terminal 4, identified by the attendee management data shown in FIG. 6 is interested, and transmits meeting attribute data of the selected one or more group meetings to the attendee terminal 4.

If the attendee using the attendee terminal 4 is “Taro Yokota”, who is interested in robots, the terminal control part 133 transmits meeting attribute data “robots, production” of F robotics related to the field of robots, to the attendee terminal 4 used by “Taro Yokota”. The terminal control part 133 may transmit the meeting attribute data of the selected one or more group meetings to the attendee terminal 4 by adding information for distinguishing the meeting attribute data of the selected one or more group meetings from meeting attribute data of other group meetings.

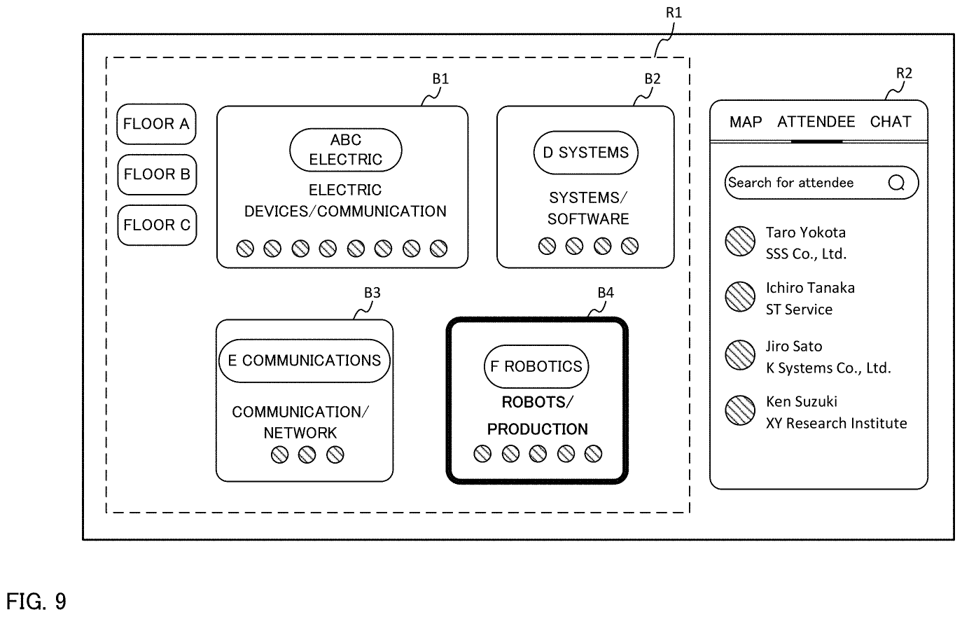

FIG. 9 shows an example of a screen where attributes of the group meeting that matches attributes of the attendee is displayed. In a display area of the booth B4 of “F robotics” in FIG. 9, the attributes “robots/production” are displayed in a manner to be larger than attributes of other booths, and also the booth B4 is emphasized more than the other booths. In this manner, the terminal control part 133 transmits, to the attendee terminal 4, the meeting attribute data of the group meeting corresponding to the attributes of the attendee, and the attendee terminal 4 emphatically displays the attributes of the group meeting. This prevents the attendee from missing the group meeting related to the attendee's field of interest. Furthermore, for the exhibitor company organizing the group meeting, the attendee having interests in the company's business field is highly likely to attend the meeting. Thus, attendance at an event will be worthwhile for both the attendee and the exhibitor company.

The terminal control part 133 may transmit, to the attendee terminal 4, meeting attribute data of one or more group meetings that another attendee, having the same attribute as the attribute indicated by the attendee attribute data corresponding to the attendee, is attending. Specifically, the terminal control part 133 references the attendee management data, and extracts the other attendee having the same attribute as that of the attendee using the attendee terminal 4. The terminal control part 133 identifies the group meeting that the extracted other attendee is attending, and identifies meeting attribute data of the identified group meeting by referencing the group meeting management data.

The terminal control part 133 transmits the meeting attribute data identified in this manner to the attendee terminal 4. This enables the attendee terminal 4 to recommend the attendee for the group meeting that another attendee, having the same attribute as that of the attendee using the attendee terminal 4, is attending. As a result, the attendee can grasp which group meeting the other attendee, having the same attribute as that of the attendee, is attending, and therefore it is easier for the attendee to select the group meeting to attend.

The terminal control part 133 may transmit, to the attendee terminal 4, meeting attribute data of one or more group meetings that a preset number or more of other attendees, having the same attribute as the attribute indicated by the attendee attribute data corresponding to the attendee, are attending. A group meeting that a large number of other attendees, having the same attribute as that of the attendee, is attending is possibly worth attending for the attendee. Therefore, by grasping attributes of such a group meeting, it is possible to prevent the attendee from missing a group meeting that is worth attending.

Among group meetings associated with fields related to group meetings corresponding to a field of interest indicated by the attendee attribute data in the meeting attribute data, the terminal control part 133 may select one or more group meetings that a preset number or more of other attendees, who show interest in the same field as the attendee according to the attendee attribute data corresponding to the attendee, and may transmit the meeting attribute data of the selected group meeting to the attendee terminal 4. The terminal control part 133 configured in this manner makes it possible to easily transmit information concerning a group meeting highly relevant to the attendee.

As an example, the preset number of people may be set for each field of the meeting. In this case, for each group meeting, the terminal control part 133 determines the number of people set for each field of the meeting on the basis of the field of the meeting associated with the meeting management data. Then, the terminal control part 133 transmits, to the attendee terminal 4, meeting attribute data of one or more group meetings that the number, set for each field of the meeting, or more of other attendees, who show interest in the same field as the attendee according to the attendee attribute data corresponding to the attendee, are attending.

Further, the terminal control part 133 may change the preset number of people on the basis of a relationship between the attributes of the attendee and attributes of the meeting. For example, the terminal control part 133 calculates a threshold of the number of attendees by subtracting, from the preset number of people, the number of people attending a group meeting, for which attributes indicated by the meeting management data match the attributes of the attendee indicated by the attendee management data. The terminal control part 133 transmits, to the attendee terminal 4, meeting attribute data of one or more group meetings that a threshold or more of the calculated number of other attendees, who show interest in the same field as the attendee in the attendee attribute data corresponding to the attendee, are attending.

Further, the preset number of people may be determined on the basis of the total number of attendees of the group meeting. In this case, the terminal control part 133 references the attendee management data to identify the number of all attendees attending the group meeting. The terminal control part 133 multiplies the identified number of attendees by a predetermined coefficient to identify the preset number of people.

Further, if the attendee registers a plurality of fields of interest as the attendee attribute data, the terminal control part 133 may select a group meeting that the preset number or more of other attendees, having fields of interest similar to the attendee, are attending, and may transmit meeting attribute data of the selected group meeting to the attendee terminal 4.

For example, the terminal control part 133 references the attendee management data, and calculates the similarity in interests between the attendee and another attendee. Then, the terminal control part 133 determines that another attendee whose similarity is equal to or greater than a predetermined threshold is another attendee having a field of interest similar to the attendee. Then, the terminal control part 133 calculates the number of other attendees having fields of interest similar to the attendee among other attendees attending the group meeting, and determines whether the calculated number of other attendees is equal to or greater than the preset number of people.

As an example, a case where fields of interest of an “attendee A”, an “attendee B”, and an “attendee C” are “AI, robots, measurement”, “AI, robots, office machinery”, and “robots, manufacturing, tools”, respectively, will be described as an example. In this case, the “attendee A” and the “attendee B” match in fields of interest in “AI, robots” and the similarity is 66%. On the other hand, since the attendee A or the attendee B, and the attendee C have the same field of interest only in “robots”, the similarity is 33%. If a threshold of the similarity is set to 40%, for example, the terminal control part 133 determines that the attendee A and the attendee B are similar attendees because the similarity is equal to or greater than the threshold. Then, since the similarity between the attendee A or attendee B and the attendee C is less than the threshold, the terminal control part 133 determines that the attendee A or the attendee B, and the attendee C is a non-similar attendee.

Together with such meeting attribute data, the terminal control part 133 may transmit, to the attendee terminal 4, attribute data of another attendee attending the group meeting. Further, the terminal control part 133 may transmit, to the attendee terminal 4, data indicating the number of attendees attending the group meeting for each attribute. The terminal control part 133 transmitting such information to the attendee terminal 4 enables the attendee to grasp what type of attendee is attending each group meeting, thereby making it easier for the attendee to determine which group meeting he/she should attend while referencing attributes of other attendees.

The terminal control part 133 may transmit meeting attribute data of one or more group meetings to the attendee terminal 4, on condition that attributes indicated by the attendee attribute data indicate that the attendee has the qualification indicated by the meeting attribute data. For example, the group meeting management data shown in FIG. 7 indicates that an invitation is necessary to attend the group meeting of D systems. In this case, in the attendee management data shown in FIG. 6, the terminal control part 133 transmits the meeting attribute data of D systems to the attendee terminal 4 of “Suzuki Hanako” having the invitation from D systems.

On the other hand, even if a field of interest of an attendee is related to communication or networks, the terminal control part 133 does not transmit the meeting attribute data of D systems to attendees who do not have invitations from D systems. The terminal control part 133 operating in this manner allows an exhibitor company organizing the group meeting to have control so that desired attendees can have priority to attend the group meeting.

The terminal control part 133 may cause the attendee terminal 4 to display a screen for searching for one or more group meetings from a plurality of group meetings, and may transmit, to the attendee terminal 4, meeting attribute data of one or more group meetings associated with meeting attribute data indicating an attribute corresponding to a keyword input in the attendee terminal 4. If the attendee using the attendee terminal 4 inputs “communication” as a search keyword, for example, the terminal control part 133 transmits, to the attendee terminal 4, meeting attribute data of “ABC electric” and “E communications” including “communication” in the attribute data, in association with respective meeting IDs. Upon receiving the meeting attribute data, the attendee terminal 4 displays the received meeting attribute data in a manner to be easily recognized by the attendee.

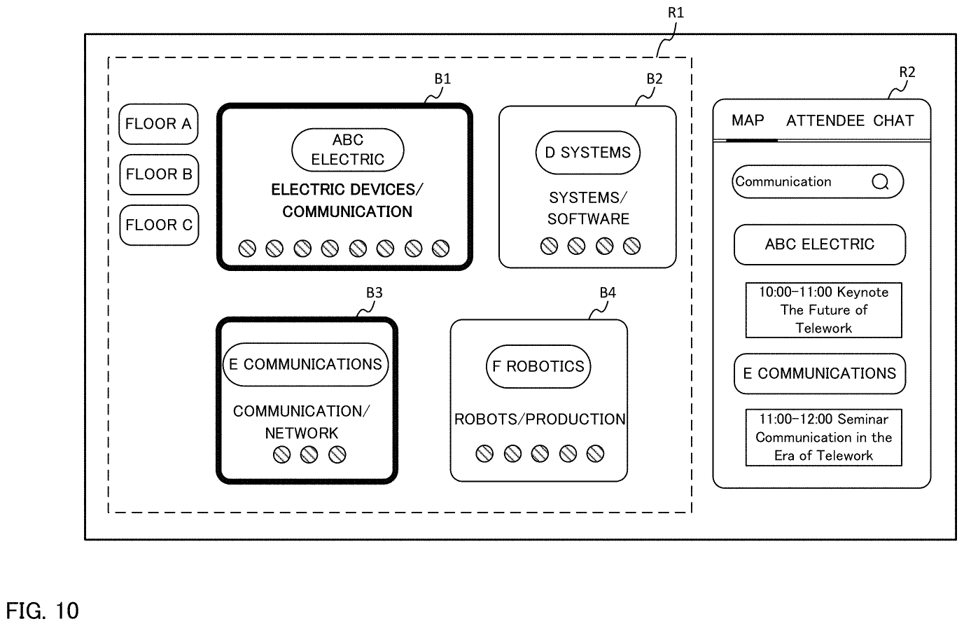

FIG. 10 shows an example of a screen including an area for searching for a group meeting. In FIG. 10, a search screen is displayed in an area R2, and schedules of “ABC electric” and “E communications” are displayed in the area R2 in response to the attendee inputting “communication” as a keyword. In addition, attributes of each group meeting are emphatically displayed in the booth B1 of “ABC electric” and the booth B3 of “E communications” in an area R1. Since the terminal control part 133 transmits the meeting attribute data to the attendee terminal 4 in accordance with the result of the attendee searching in this manner, the attendee can easily attend the group meeting related to the attendee's field of interest.

As shown in FIG. 7, the storage part 12 stores, as the meeting attribute data, data indicating whether or not the attendee of the group meeting can shift to another group meeting while the group meeting is ongoing. By using this information, the terminal control part 133 may stop notification of meeting attribute data of other group meetings, to the attendee terminal 4 used by an attendee at a shifting-prohibited group meeting, where it is not allowable to shift to another group meeting, while the shifting-prohibited group meeting is ongoing.

Since the attendee terminal 4 of the attendee at the group meeting where shifting is prohibited is not notified of the meeting attribute data of other group meetings, the attendee has no way to know details of talks in the other group meetings. Therefore, it is difficult for the attendee to shift from a currently-attended group meeting to another group meeting. Since the terminal control part 133 and the attendee terminal 4 operate in this manner, the exhibitor company organizing the group meeting can have the attendee be focused on their explanations.

### [Flow of Processing in the Meeting Management Apparatus 1]

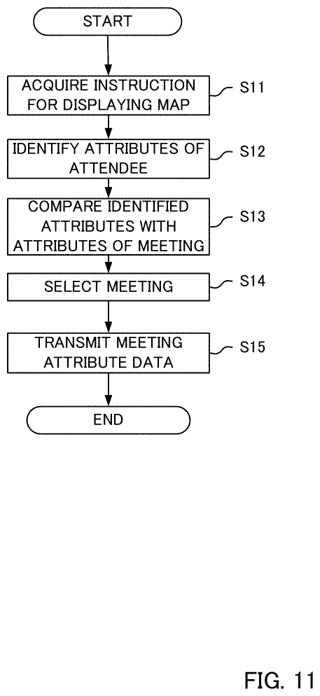

FIG. 11 is a flowchart showing an example of a flow of processing in the meeting management apparatus 1. The flowchart shown in FIG. 11 starts from when a plurality of group meetings are held.

If the data acquiring part 131 acquires an instruction for displaying a map of the plurality of group meetings from any one of the plurality of attendee terminals 4 (S11), the terminal control part 133 references the attendee management data to identify attributes of the attendee who has given the instruction (S12). Next, the terminal control part 133 references the group meeting management data to compare the attributes of the identified attendee with attributes of meetings (S13), and selects a group meeting having a common attribute (S14). The terminal control part 133 transmits meeting attribute data of the selected group meeting to the attendee terminal 4 (S15).

### Modified Example

In the above description, a case where the attributes of the attendee are included in the attendee management data has been exemplified, but the attributes of the attendee may not be known in advance. In order that the terminal control part 133 can identify a group meeting suitable for the attendee in such a case, the meeting management apparatus 1 may manage history of group meetings that the attendee attended, and may estimate the attributes of the attendee on the basis of attendance history of the attendee.

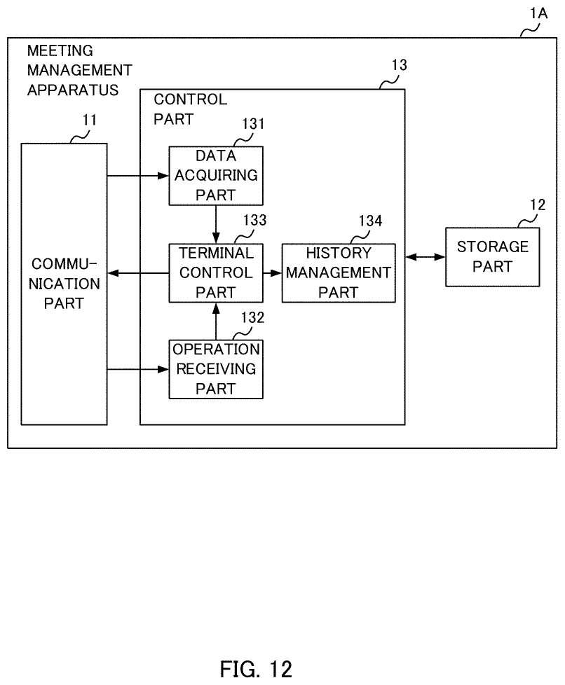

FIG. 12 shows a configuration of a meeting management apparatus 1A according to a modified example. The meeting management apparatus 1A shown in FIG. 12 differs from the meeting management apparatus 1 shown in FIG. 5 in that the meeting management apparatus 1A further includes a history management part 134, and is the same as the meeting management apparatus 1 in all other ways.

As attendance history information, the history management part 134 stores a meeting ID, which is meeting identification information for identifying a group meeting that the attendee attended, in the storage part 12 in association with the attendee. By referencing the attendance history information, the terminal control part 133 identifies the group meeting that the attendee attended in the past, and transmits, to the attendee terminal 4, meeting attribute data of another group meeting having the same attribute as that of the identified group meeting.

For example, if the terminal control part 133 identified that an attendee attended a group meeting of “ABC electric”, the terminal control part 133 transmits, to the attendee terminal 4 of the attendee, meeting attribute data of “E communications” having an attribute (communication), which is common to at least a portion of attributes of “ABC electric” (electric device, communication). Even if the attributes of the attendee are not registered in the meeting management apparatus 1, the terminal control part 133 operating in this manner can notify the attendee of the attributes of the group meeting suitable for the attendee so that the attendee can easily determine which group meeting he/she should attend.

The terminal control part 133 may transmit the attendance history information to the attendee terminal 4 in response to a request from the attendee terminal 4. Since the terminal control part 133 operating in this manner allows the attendee to check which group meeting he/she attended, the attendee can easily check whether there is any group meeting he/she has forgotten to attend.

### [Effect of the Meeting Management System S]

As described above, in the meeting management apparatus 1, the storage part 12 stores the meeting attribute data in association with each of a plurality of group meetings. Then, the terminal control part 133 transmits, to the attendee terminal 4, meeting attribute data corresponding to each of the plurality of group meetings in association with respective meeting IDs of each of the plurality of group meetings. Since the attendee terminal 4 displays information based on received meeting attribute data, it is easier for the attendee who will attend meetings via a network to determine which group meeting he/she should attend.

Further, it becomes easier for the exhibitor company to have an attendee, having attributes preferable for the exhibitor company, attend the group meeting by appropriately setting attributes of the group meeting. Furthermore, a host of an event can have the attendee shift to an appropriate group meeting (booth), thus the value of the event can be enhanced.

The present disclosure has been described above on the basis of the exemplary embodiments. The technical scope of the present disclosure is not limited to the scope explained in the above embodiments, and it is obvious to those skilled in the art that various changes and modifications within the scope of the invention may be made. An aspect to which such changes and modifications are added can be included in the technical scope of the present invention is obvious from the description of the claims.

What is claimed is:

1. A meeting management apparatus managing a plurality of group meetings that a plurality of attendees can attend using a communication terminal, the meeting management apparatus comprising:
a memory that stores meeting attribute data indicating an attribute of the group meeting in association with each of the plurality of group meetings; and
a processor that functions as a terminal control part that transmits, to the communication terminal, the meeting attribute data corresponding to each of the plurality of group meetings in association with meeting identification information for identifying each of the plurality of group meetings.

2. The meeting management apparatus according to claim 1, wherein
the memory further stores attendee attribute data indicating an attribute of the attendee in association with each of the plurality of attendees, and
the terminal control part transmits, to the communication terminal, the meeting attribute data of one or more group meetings selected from the plurality of group meetings on the basis of a relationship between the attendee attribute data and the meeting attribute data.

3. The meeting management apparatus according to claim 2, wherein
the terminal control part transmits, to the communication terminal, the meeting attribute data of one or more group meetings that another attendee, having the same attribute as an attribute indicated by the attendee attribute data corresponding to the attendee, is attending.

4. The meeting management apparatus according to claim 3, wherein
the terminal control part transmits, to the communication terminal, the meeting attribute data of one or more group meetings that a preset number or more of other attendees, having the same attribute as an attribute indicated by the attendee attribute data corresponding to the attendee, are attending.

5. The meeting management apparatus according to claim 2, wherein
the memory stores data indicating a qualification necessary for attending the group meeting as the meeting attribute data, and
the terminal control part transmits the meeting attribute data of the one or more group meetings to the communication terminal, on condition that an attribute indicated by the attendee attribute data indicates that the attendee has the qualification indicated by the meeting attribute data.

6. The meeting management apparatus according to claim 1, wherein
the terminal control part causes the communication terminal to display a screen for searching for one or more group meetings from the plurality of group meetings, and transmits, to the communication terminal, the meeting attribute data of one or more group meetings associated with the meeting attribute data indicating an attribute corresponding to a keyword input in the communication terminal.

7. The meeting management apparatus according to claim 1, wherein
the processor further functions as a history management part that stores, in the memory, meeting identification information for identifying the group meeting that the attendee attended, as attendance history information in association with the attendee, and
by referencing the attendance history information, the terminal control part identifies the group meeting that the attendee attended in the past, and transmits, to the communication terminal, the meeting attribute data of another group meeting having the same attribute as that of the identified group meeting.

8. The meeting management apparatus according to claim 1, wherein
the processor further functions as a history management part that stores, in the memory, meeting identification information for identifying the group meeting that the attendee attended, as attendance history information in association with the attendee, and
the terminal control part transmits the attendance history information to the communication terminal in response to a request from the communication terminal.

9. The meeting management apparatus according to claim 1, wherein
the memory stores, as the meeting attribute data, data indicating whether or not the attendee at the group meeting can shift to another group meeting while the group meeting is ongoing, and
while a shifting-prohibited group meeting, which is a group meeting where it is not allowable to shift to another group meeting, is ongoing, the terminal control part stops notification of the meeting attribute data of another group meeting to the communication terminal used by the attendee at the shifting-prohibited group meeting.

10. The meeting management apparatus according to claim 1, wherein
the memory further stores attendee attribute data indicating a field of interest of the attendee in association with each of the plurality of attendees, and
among the group meetings associated with a field related to the group meeting corresponding to the field of interest indicated by the attendee attribute data in the meeting attribute data, the terminal control part selects one or more group meetings that a preset number or more of other attendees, who show interest in the same field as the field of interest indicated by the attendee attribute data corresponding to the attendee in the attendee attribute data, are attending.

11. The meeting management apparatus according to claim 1, wherein
the memory further stores attendee attribute data indicating a field of interest of the attendee in association with each of the plurality of attendees, and
the terminal control part selects the group meeting associated with a field related to the group meeting corresponding to the field of interest indicated by the attendee attribute data in the meeting attribute data, and transmits, to the communication terminal, characters indicating a field related to the selected group meeting as the meeting attribute data.

12. A meeting management method, executed by a computer, for managing a plurality of group meetings that a plurality of attendees can attend using a communication terminal, the meeting management method comprising the steps of:
reading meeting attribute data indicating an attribute of the group meeting stored in a memory in association with each of the plurality of group meetings; and
transmitting the meeting attribute data corresponding to each of the plurality of group meetings to the communication terminal, in association with meeting identification information for identifying each of the plurality of group meetings.

13. A meeting management system comprising: a plurality of communication terminals used by a plurality of attendees; and a meeting management apparatus managing a plurality of group meetings that the attendee can attend using the communication terminal, wherein
the meeting management apparatus includes:
a memory that stores meeting attribute data indicating an attribute of the group meeting in association with each of the plurality of group meetings; and
a processor that functions as a terminal control part that transmits the meeting attribute data corresponding to each of the plurality of group meetings to the communication terminal, in association with meeting identification information for identifying each of the plurality of group meetings, wherein
the communication terminal includes:
a receiver that receives the meeting attribute data; and
a display that displays the meeting attribute data received by the receiver at a position corresponding to the group meeting according to the meeting attribute data.
